(19) United States
(12) Patent Application Publication
(10) Pub. No.: US 2011/0247059 A1
(43) Pub. Date: Oct. 6, 2011

(54) Methods and Apparatus for Role-Based Shared Access Control to a Protected System Using Reusable User Identifiers

(75) Inventors: Evelyn R. Anderson, Houston, TX (US); Mohit Chugh, San Francisco, CA (US); Milton H. Hernandez, Tenafly, NJ (US); Martin McLaughlin, Glasgow (GB); Karthik Subramanian, Summerhill (SG); Prema Vivekanandan, Kansas City, MO (US)

(73) Assignee: INTERNATIONAL BUSINESS MACHINES CORPORATION, Armonk, NY (US)

(21) Appl. No.: 12/751,461

(22) Filed: Mar. 31, 2010

(51) Int. Cl. H04L 9/32; G06F 21/00

(52) U.S. Cl. 726/6; 726/7

(57) ABSTRACT

Methods and apparatus are provided for role-based shared access control to a protected system using reusable user identifiers while maintaining individual accountability. Role-based access control is provided for a protected system by receiving a request from an end user to access a given protected system; determining a role of the end user for the access to the given protected system; receiving a privileged reusable user identifier and password for the given protected system and role; and providing the privileged reusable user identifier and password to the given protected system on behalf of the end user. Role-based access control is also provided for a protected system by receiving a request to verify an end user requesting access to a given protected system; determining a role of the end user for the access to the given protected system; and providing a privileged reusable user identifier and password for the given protected system and role. A status of the privileged reusable user identifier and password can optionally be maintained. One or more events associated with the privileged reusable user identifier and password can be logged and investigated.

### FIELD OF THE INVENTION

The present invention relates generally to access control techniques, and more particularly, to access control techniques for shared user accounts, such as administrative accounts.

### BACKGROUND OF THE INVENTION

The various hardware and software systems of an enterprise, such as servers, databases, network devices and numerous applications, are maintained and controlled through a number of administrative accounts. Thus, enterprises typically have a large number of highly sensitive and “privileged” administrative user accounts that must be protected from unauthorized access. Further, these “privileged” accounts are extremely powerful, typically allowing a user to logon on anonymously, with virtually complete control of the target system. Users with such system level administrative authority can improperly use their authority to alter system components and to access sensitive information on the system.

Typically, an enterprise has several functional groups and each group has access to specific passwords. The privileged accounts are generally accessible to all of the members of the group. Unfortunately, the passwords associated with privileged administrative accounts are often shared among members in the group. Thus, a group of administrators use a common privileged account to access a given resource, thereby losing individual accountability. Generally, “individual accountability” requires that an action can be traced to a specific individual.

While the security and operational problems associated with shared administrative passwords are well known, enterprises have been unable to eliminate them altogether. Password vaults, such as Cyber-Ark's Enterprise Password Vault (EPV), commercially available from Cyber-Ark Software, Inc. of Newton, Mass., have been used to allow users to retrieve a user identifier and password for privileged accounts following a self registration. The retrieved user identifier and password, however, can still be shared with other individuals. Thus, individual accountability is not maintained.

A need therefore exists for methods and apparatus for shared access control to a protected system that maintains individual accountability. A further need exists for methods and apparatus for shared access control to a protected system that do not reveal a password for a privileged account to an end user. Yet another need exists for methods and apparatus for shared access control to a protected system that validates the role of an end user before the user is permitted to access a protected system.

### SUMMARY OF THE INVENTION

Generally, methods and apparatus are provided for role-based shared access control to a protected system using reusable user identifiers while maintaining individual accountability. According to one aspect of the invention, role-based access control is provided for a protected system by receiving a request from an end user to access a given protected system; determining a role of the end user for the access to the given protected system; receiving a privileged reusable user identifier and password for the given protected system and role; and providing the privileged reusable user identifier and password to the given protected system on behalf of the end user. The end user request may optionally include an identifier of the end user and an identifier of the given protected system.

According to another aspect of the invention, role-based access control is provided for a protected system by receiving a request to verify an end user requesting access to a given protected system; determining a role of the end user for the access to the given protected system; and providing a privileged reusable user identifier and password for the given protected system and role. A status of the privileged reusable user identifier and password can optionally be maintained.

In further variations, the identity of the end user is optionally verified. In addition, one or more permissable roles for the end user on the given protected system can be determined and a user can select a role for the access. Another aspect of the invention allows one or more events associated with the privileged reusable user identifier and password to be logged and investigated.

A more complete understanding of the present invention, as well as further features and advantages of the present invention, will be obtained by reference to the following detailed description and drawings.

### BRIEF DESCRIPTION OF THE DRAWINGS

FIG. 1 illustrates an exemplary shared access control system in accordance with the present invention;

FIG. 2 illustrates the identity database and password vault of FIG. 1 in further detail;

FIG. 3 is a flow chart describing an exemplary implementation of an end user system access process that incorporates features of the present invention;

FIG. 4 illustrates the logging of events in the shared access control system of FIG. 1; and

FIG. 5 depicts a computer system that may be useful in implementing one or more aspects and/or elements of the present invention.

### DETAILED DESCRIPTION OF PREFERRED EMBODIMENTS

One aspect of the present invention provides methods and apparatus for role-based shared access control to a protected system using reusable user identifiers while maintaining individual accountability. As discussed further below, a reusable user identifier allows the end user to log into a protected system without having or knowing the password of the user account that the end user is using to log onto the system. Thus, a further aspect of the invention provides shared access control to a protected system without revealing the password for the privileged account to the end user. In this manner, the password cannot be shared with other individuals. Another aspect of the invention provides shared access control to a protected system based on a role validation of the end user before the user is permitted to access the protected system.

As discussed hereinafter, the disclosed reusable user identifiers can be used by multiple individuals based on the role that the individual is currently performing in a given system, allowing the user to log-on to the system without knowing the password at any point in time. Among other benefits, the end users of the privileged accounts do not know the password and thus cannot share the password.

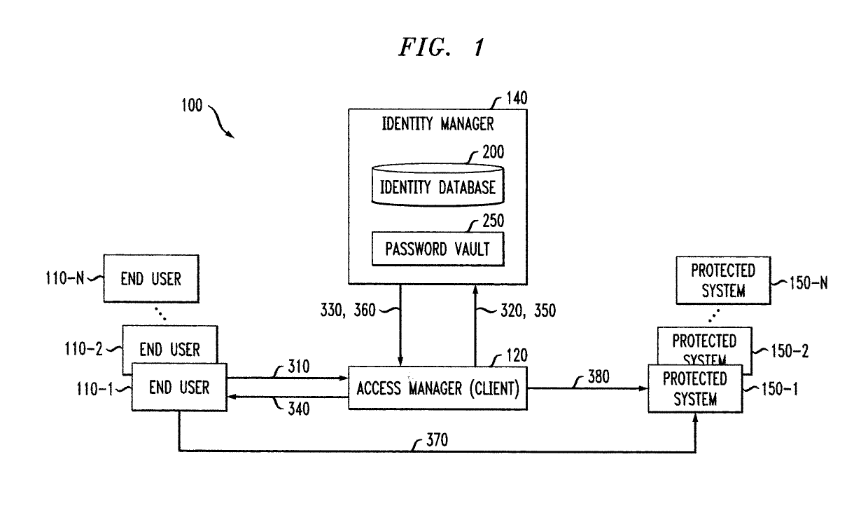

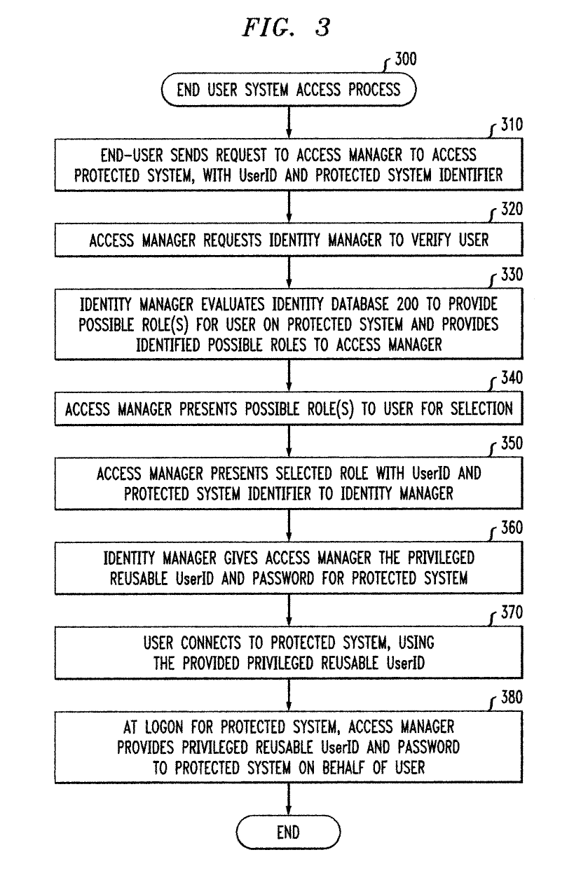

FIG. 1 illustrates an exemplary shared access control system 100 in accordance with the present invention. As shown in FIG. 1, the exemplary shared access control system 100 allows a plurality of end users 110-1 through 110-N to share one or more administrative accounts to access one or more protected systems 150-1 through 150-N. The flow of information among the various entities in FIG. 1 is discussed further below in conjunction with FIG. 3.

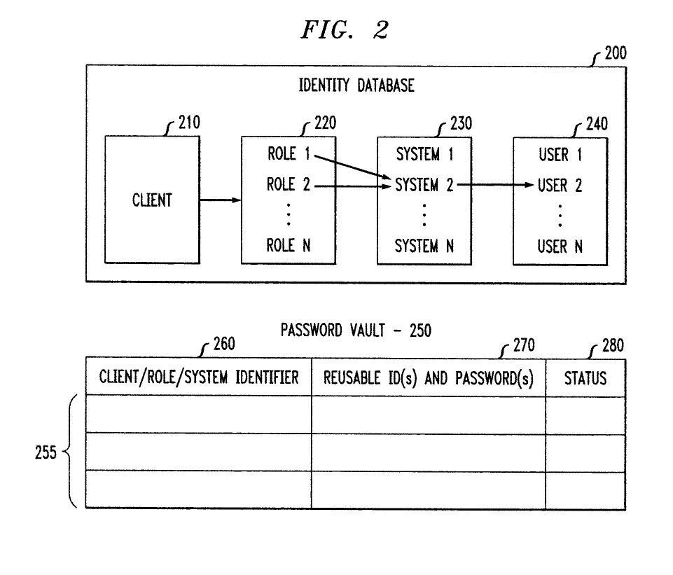

As discussed further below in conjunction with FIG. 3, in one exemplary embodiment, access control is managed using an access manager 120 and an identity manager 140. In one exemplary embodiment, the access manager 120 is implemented as a client on the computing system of the corresponding end user 110. As discussed further below in conjunction with FIG. 2, the identity manager 140 verifies the identity and privileges of the end user 110 using an identity database 200. In addition, once the user is verified in accordance with the present invention, the identity manager 140 obtains an appropriate password from a password vault 250.

FIG. 2 illustrates the identity database 200 and password vault 250 of FIG. 1 in further detail. Generally, as discussed further below in conjunction with FIG. 3, the identity manager 140 verifies the identity and privileges of the end user 110 using the identity database 200. The exemplary identity database 200 shown in FIG. 2 may be implemented, for example, using a plurality of bidirectional indexes. The indexes may be traversed in either direction, as would be apparent to a person of ordinary skill in the art.

As shown in FIG. 2, the identity database 200 may optionally store unique identity information for each client (customer), identified in field 210. In addition, for each client, the identity database may indicate the permitted roles associated with each client in field 220. Each permitted role in field 220 can point to the corresponding systems in field 230 upon which the particular role is authorized. Finally, for each system identified in field 220, the identity database 200 identifies the authorized users (for example, by userID) in field 240.

As indicated above, once the user is verified in accordance with the present invention, the identity manager 140 obtains an appropriate password from a password vault 250, also shown in FIG. 2. As shown in FIG. 2, the exemplary password vault 250 stores a number of user identifiers and corresponding passwords for various systems and roles of a given client (customer).

The exemplary password vault 250 identifies the client, role and system for a given password in field 260. The reusable user identifier and corresponding password is recorded in field 270, and the status of the password is indicated in field 280. For example, the possible status entries may comprise “Checked out,” “log on,” and “checked in.” The password provided for a given system and role provide appropriate system access for the associated role.

FIG. 3 is a flow chart describing an exemplary implementation of an end user system access process 300 that incorporates features of the present invention. It is noted that the step numbers of FIG. 3 are also shown as labels in FIG. 1 between the two entities participating in the respective communication. During step 310, the end-user initially sends a request to the access manager 120 to access a particular protected system 150. The user request during step 310 optionally includes the identifier of the user and an identifier of the protected system to be accessed.

During step 320, the access manager 120 sends a request to the identity manager 140 to verify the particular user. The identity manager 140 then evaluates the identity database 200 during step 330 to identify the permissable role(s) for the user on the particular protected system. Generally, the identity manager 140 first uses the user identifier to determine the systems 230 upon which the user is authorized. The identity manager 140 then determines the permissible roles 220 for the authorized systems 230. The identified possible roles are then provided to the access manager 120 during step 330.

During step 340, the access manager 120 presents the list of possible role(s) to the user for selection of a particular role for this access. During step 350, the access manager 120 presents the role selected by the user with the user identifier and protected system identifier to the identity manager 140.

The identity manager 140 gives the access manager 120 the privileged reusable userid and password for the particular protected system and role during step 360. During step 370, the user connects to the particular protected system 150, using the provided privileged reusable userid. During step 380, during a logon routine for the protected system 150, the access manager 120 provides the privileged reusable userid and password to the protected system 150 on behalf of the user 110.

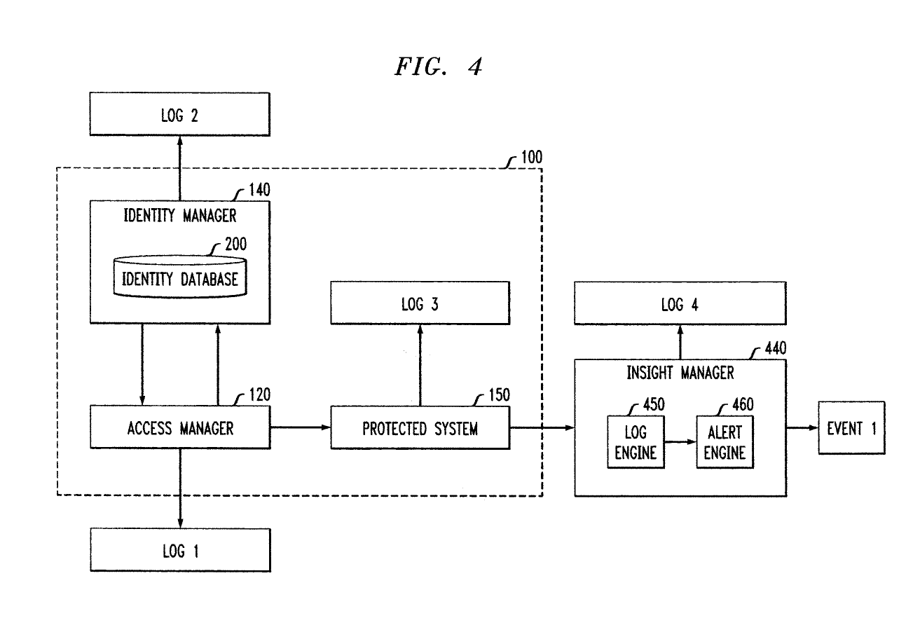

FIG. 4 illustrates the logging of events in the shared access control system 100 of FIG. 1. In one exemplary embodiment, an audit trail is obtained by logging the various stages of the end user system access process 300 when a user attempts to access a protected system 150. In one variation the logged events can be monitored to trigger alerts following a predefined event.

As shown in FIG. 4, the shared access control system 100 optionally also comprises an insight manager 440 to log events. The exemplary insight manager 440 comprises a log engine 450 and an alert engine 460.

As shown in FIG. 4, the access manager 120 creates a first log (Log 1) comprising, for example, three audit trail records during the lifecycle of a log-in by an end user 110: (i) a check-out of a reusable UserID; (ii) an autofill of credentials (UserID and Password) and (iii) a check-in of the reusable UserID back into the pool following use.

The identity manager 140 creates a second log (Log 2) comprising an audit trail for the password reset/changes done by the user owner of the reusable USerID.

The protected system 150 creates a third log (Log 3) comprising log records for each of the activities performed by the end user 110, such as the log-in, log-off and any password change.

The log engine 450 in the insight manager 440 will monitor key privileged activities. The log engine 450 will generate a fourth log (Log 4) comprising any suspicious activities. The alert engine 460 will generate one or more predefined events that become candidates for investigation.

Exemplary System and Article of Manufacture Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

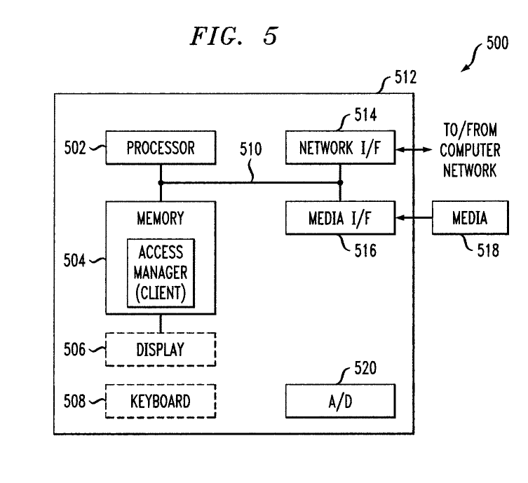

One or more embodiments can make use of software running on a general purpose computer or workstation. FIG. 5 depicts a computer system 500 that may be useful in implementing one or more aspects and/or elements of the present invention. With reference to FIG. 5, such an implementation might employ, for example, a processor 502, a memory 504, and an input/output interface formed, for example, by a display 506 and a keyboard 508. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for, example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 502, memory 504, and input/output interface such as display 506 and keyboard 508 can be interconnected, for example, via bus 510 as part of a data processing unit 512. Suitable interconnections, for example via bus 510, can also be provided to a network interface 514, such as a network card, which can be provided to interface with a computer network, and to a media interface 516, such as a diskette or CD-ROM drive, which can be provided to interface with media 518.

Analog-to-digital converter(s) 520 may be provided to receive analog input, such as analog video feed, and to digitize same. Such converter(s) may be interconnected with system bus 510.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 502 coupled directly or indirectly to memory elements 504 through a system bus 510. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 508, displays 506, pointing devices, and the like) can be coupled to the system either directly (such as via bus 510) or through intervening I/O controllers (omitted for clarity).

Network adapters such as network interface 514 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 512 as shown in FIG. 5) running a server program. It will be understood that such a physical server may or may not include a display and keyboard.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Media block 518 is a non-limiting example. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the FIGS. illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Method steps described herein may be tied, for example, to a general purpose computer programmed to carry out such steps, or to hardware for carrying out such steps, as described herein. Further, method steps described herein, including, for example, obtaining data streams and encoding the streams, may also be tied to physical sensors, such as cameras or microphones, from whence the data streams are obtained.

It should be noted that any of the methods described herein can include an additional step of providing a system comprising distinct software modules embodied on a computer readable storage medium. The method steps can then be carried out using the distinct software modules and/or sub-modules of the system, as described above, executing on one or more hardware processors 502. In some cases, specialized hardware may be employed to implement one or more of the functions described here. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A role-based method for controlling access to a protected system, comprising:
receiving a request from an end user to access a given protected system;
determining a role of said end user for said access to said given protected system;
receiving a privileged reusable user identifier and password for said given protected system and role; and
providing said privileged reusable user identifier and password to said given protected system on behalf of said end user.

2. The method of claim 1, wherein said end user request includes an identifier of said end user and an identifier of said given protected system.

3. The method of claim 1, further comprising the step of verifying an identity of said end user.

4. The method of claim 1, further comprising the steps of determining one or more permissable roles for said end user on said given protected system and receiving a user selection of a role for said access.

5. The method of claim 1, further comprising the step of logging one or more events associated with said privileged reusable user identifier and password.

6. A role-based method for controlling access to a protected system, comprising:
receiving a request to verify an end user requesting access to a given protected system;
determining a role of said end user for said access to said given protected system; and
providing a privileged reusable user identifier and password for said given protected system and role.

7. The method of claim 6, further comprising the step of verifying an identity of said end user.

8. The method of claim 6, further comprising the steps of identifying one or more permissable roles for said end user on said given protected system and receiving a user selection of a role for said access.

9. The method of claim 6, further comprising the step of updating a status of said privileged reusable user identifier and password.

10. The method of claim 6, further comprising the step of preventing use of said privileged reusable user identifier and password while being used by said end user.

11. The method of claim 6, further comprising the step of logging one or more events associated with said privileged reusable user identifier and password.

12. An apparatus for role-based access control for a protected system, the apparatus comprising:
a memory; and
at least one processor, coupled to the memory, operative to:
receive a request from an end user to access a given protected system;
determine a role of said end user for said access to said given protected system;
receive a privileged reusable user identifier and password for said given protected system and role; and
providing said privileged reusable user identifier and password to said given protected system on behalf of said end user.

13. The apparatus of claim 12, wherein said end user request includes an identifier of said end user and an identifier of said given protected system.

14. The apparatus of claim 12, wherein said processor is further configured to verify an identity of said end user.

15. The apparatus of claim 12, wherein said processor is further configured to determine one or more permissable roles for said end user on said given protected system and receive a user selection of a role for said access.

16. The apparatus of claim 12, wherein said processor is further configured to log one or more events associated with said privileged reusable user identifier and password.

17. An apparatus for role-based access control for a protected system, the apparatus comprising:
a memory; and
at least one processor, coupled to the memory, operative to:
receive a request to verify an end user requesting access to a given protected system;
determine a role of said end user for said access to said given protected system; and
provide a privileged reusable user identifier and password for said given protected system and role.

18. The apparatus of claim 17, wherein said processor is further configured to verify an identity of said end user.

19. The apparatus of claim 17, wherein said processor is further configured to identify one or more permissable roles for said end user on said given protected system and receive a user selection of a role for said access.

20. The apparatus of claim 17, wherein said processor is further configured to update a status of said privileged reusable user identifier and password.

21. The apparatus of claim 17, wherein said processor is further configured to prevent use of said privileged reusable user identifier and password while being used by said end user.

22. The apparatus of claim 17, wherein said processor is further configured to log one or more events associated with said privileged reusable user identifier and password.
